(19) United States
(12) Patent Application Publication
(10) Pub. No.: US 2012/0203586 A1
(43) Pub. Date: Aug. 9, 2012

(54) Field Service Networking Platform

(75) Inventor: Vance Blakely, Spokane, WA (US)

(73) Assignee: FreeFieldService.com, Spokane, WA (US)

(21) Appl. No.: 13/368,070

(22) Filed: Feb. 7, 2012

Related U.S. Application Data
(60) Provisional application No. 61/440,069, filed on Feb. 7, 2011.

(51) Int. Cl. G06Q 10/06

(52) U.S. Cl. 705/7.12; 705/1.1

(57) ABSTRACT

An agent of a service provider may visit a customer location and learn of a service need beyond the scope of services provided by the service provider. The agent may use a mobile device to access a service provider network that contains information about multiple service providers and relationships between those service providers. The mobile device may provide an unfulfilled customer service need as a customer lead to a lead pool within the service provider network. The agent may also use a mobile device to “up-serve” the customer by scheduling a service appointment with another service provider from the service provider network. That other service provider may be selected based on relationships stored in the service provider network. The type of relationships in the service provider network may include competitor, affiliate, associate, and the like. Customers may access the service provider network through a portal to directly schedule service.

### RELATED APPLICATION

This application claims priority to U.S. Provisional Application No. 61/440,069 filed on Feb. 7, 2011 which is incorporated by reference herein in its entirety.

### BACKGROUND

Many types, and sizes, of companies provide services to customers on-site or in the field. Service providers may range from a single person who provides massages at customers' homes to a multi-national corporation that provides repair services for plumbing and electrical systems in skyscrapers. The large service provider can leverage efficiencies of scale to create and utilize sophisticated systems for scheduling appointments, dispatching technicians, and providing valued-added services. However, small and micro-size service providers may be at a competitive disadvantage because they do not have access to the sophisticated systems and backend infrastructure available to larger service providers.

Service providers of all sizes may learn of customer service needs while at the customer's location. A customer may discuss other problems or service needs with an agent (e.g. a service technician) of the service provider. The agent may also identify additional service needs of which the customer was unaware. Some of the service needs may be within the scope of services provided by the service provider. However, other service needs may be for services that the service provider does not provide. For example, a plumber in a customer's home may become aware of a need for the services of an electrician. In this situation, it would be desirable to enable the service provider to assist the customer in meeting his or her service needs through another service provider in a way that also provides a benefit to the on-site service provider.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Multiple service providers may join in a service provider network. This service provider network may be analogous to “social” networks in that members of the network can establish different types of relationships with one another. For example, two service providers that provide the same service may be competitors in the business world and this competitive relationship may be represented as a “competitor relationship” in the service provider network. Service providers that provide noncompetitive and possibly complementary services may establish an “associate” relationship with one another. The associate relationship may provide opportunities for cross referrals, joint marketing, and the like. Additionally, service providers that are not competitors but have not formed the close relationship typical of “associates” may choose to connect with one another as “affiliates” in this service provider network.

When an agent of a service provider (e.g., a repair technician) visits a customer location to provide a service, the agent may learn that the customer has other service needs such as a plumber realizing that his customer has need for an electrician's services. The agent at the customer location may discuss this additional service need with the customer and offer to help the customer schedule service with an appropriate service provider (e.g., an electrician). The agent may use a mobile device, such as a smart phone, to access a calendar for the other service provider and schedule an appointment for the customer. The ability of an agent of one service provider to schedule an appointment with a different service provider is referred to herein as “up-serving.”

There may additionally be situations in which a member of the service provider network learns of an unfulfilled customer need for service. The customer may communicate this service need to an on-site technician, by calling a service provider on a telephone, by accessing a customer portal for the service provider network such as from a web browser, or by any other method of communication. The existence of an unfulfilled service need may be captured as a “customer lead” or simply “lead.” In some cases the service provider, or that service provider's agent, may be able to provide the necessary services and act on the lead. In other situations, either because of scheduling conflicts, geographic distance to the customer location, because the lead involves services that a given service provider does not provide, or for other reasons, the service provider that obtains the lead may be unable to act on the lead.

Unfulfilled leads may be provided to a lead pool associated with the service provider network. Contributors of leads to the lead pool may receive a benefit such as a token or a credit. For example, a plumber may capture a lead for electrical services and receive a benefit for contributing that lead to the lead pool. The tokens provided for contributing leads may be redeemed for other information, goods, or services. The sharing or distribution of leads may be mediated by the service provider network. For example, leads may be shared first with other service providers that are “associates” of the contributing service provider before those leads are shared with or made available to other members of the service provider network.

Members of the service provider network are not required to deliver services. The service provider network accommodates members who do not directly provide services and participate solely for the purpose of up serving other members. Members of the service provider network are associated with one or more provider codes (e.g., 1 for carpenter, 212 for masseuse, etc.) that identify the specific services offered. The members may select the service provider codes from a list when joining the service provider network. Two service providers may have some, all, or no provider codes in common. When two service providers are associated with the same provider code, those two service providers may be characterized as having a competitive relationship. Competitive relationships may be determined at the provider code level rather than at the member level. Competitive relationships may also be determined at the member level.

Members of the service provider network may also join together to form “associations.” Within an association, competitive relationships between the service providers may be prohibited. Thus, two service providers that are both associated with the same provider code may not be able to join the same association. Associations are formalized through the establishment of a “group” to which each associate joins. Associations are self-governing and managed by the member associates. In some implementations, all associates within an association must approve the addition of any new service provider to the association. However, as discussed above, some service providers, such as competitors may be prevented from joining the association based on limitations related to provider codes.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 shows an illustrative architecture that can support on-site booking of other service providers and capture of customer leads.

FIG. 2 shows the lead pool of FIG. 1 in greater detail.

FIG. 3 shows an illustrative service provider network.

FIG. 4 is a block diagram illustrating the server of FIG. 1 in greater detail.

FIG. 5 is a block diagram illustrating the mobile device of FIG. 1 in greater detail.

FIG. 6 is a flow diagram on an illustrative process for identifying a service provider to meet a customer need.

FIG. 7 is a flow diagram on an illustrative process showing additional aspects of the flow diagram in FIG. 6.

FIG. 8 is a flow diagram of an illustrative process showing additional aspects of the flow diagram in FIG. 7.

FIG. 9 is a flow diagram of an illustrative process for providing a customer lead to a lead pool.

### DETAILED DESCRIPTION

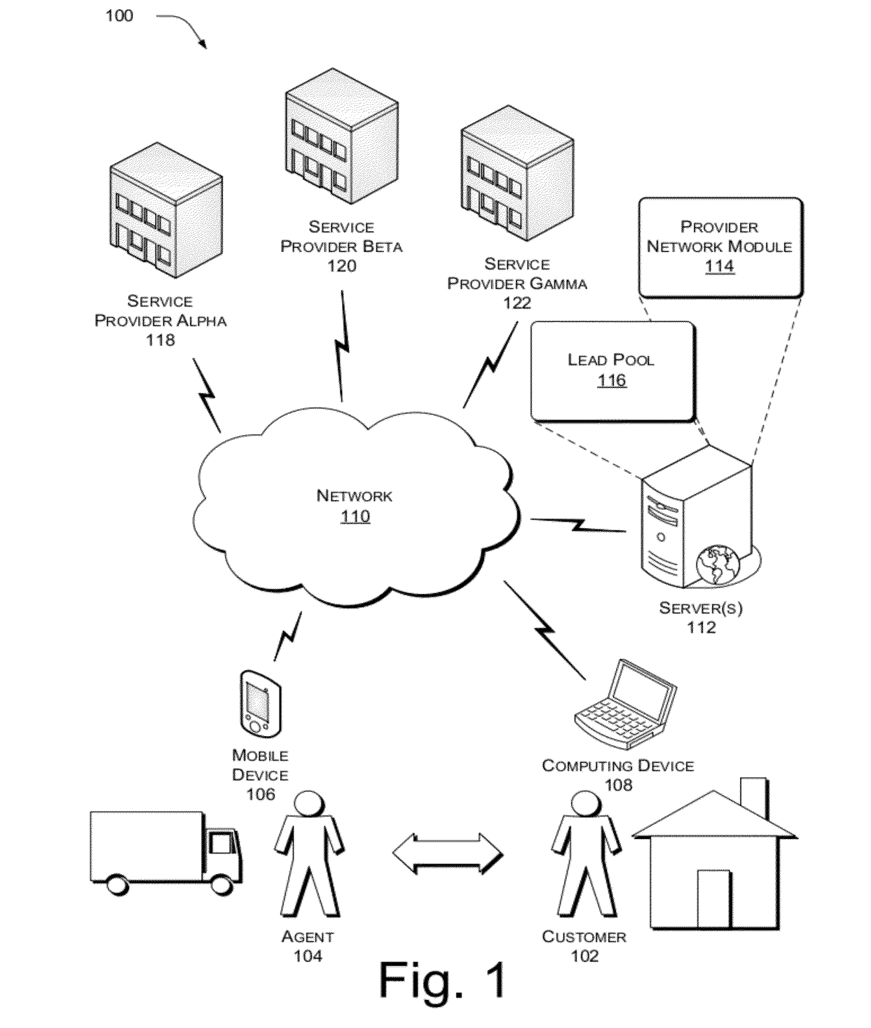

FIG. 1 shows an illustrative architecture 100 that can support on-site booking by one service provider for another service provider. The architecture 100 can also support capture of customer leads. A customer 102 receives service from an agent 104 of a service provider at a customer location such as the customer's home or workplace. The customer 102 represents any type of entity that receives services from an agent 104 of a service provider. The customer 102 may be a homeowner receiving repair services on his or her home. In other circumstances the customer 102 may be a business entity receiving services at a business location or jobsite.

The agent 104 is represented here as a single person. However, the agent 104 may also be a crew of multiple people. The agent 104 may provide any type of services such as trade services (e.g., carpentry, plumbing, HVAC installation and maintenance, electrical services, and the like) health services (e.g., nursing, massage, and the like), professional services (e.g., computer technical support, accounting, and the like), etc.

The agent 104 may bring a mobile device 106 to the customer location. The mobile device 106 may provide the agent 104 with access to the service provider network in order to “up-serve” the customer 102 and/or capture a customer lead. The mobile device 106 may be implemented as a mobile phone, a smart phone, a tablet computer, a personal digital assistant, a netbook, a laptop computer; a vehicle based computing and/or navigation system, and the like.

The customer 102 may have access to a computing device 108 such as a desktop computer, notebook computer, tablet computer, smart phone, etc. with which the customer 102 can access a customer portal of the service provider network. Both of the mobile device 106 and the computing device 108 may be communicatively connected either wired or wirelessly to a network 110. The network 110 may be any type of network capable of carrying information such as the Internet, a cable network, a telephone network, a local area network, a wide area network, a peer-to-peer network, a mesh network, and the like.

One or more servers 112 communicatively connected to the network 110 may support the service provider network. The service provider network includes the actual companies and people providing the service as well as the computer-based representation of relationships between those companies and people. The computer-based representation of relationships may include a service provider network module 114 that manages various aspects of the service provider network and a lead pool 116 into which customer leads may be added or withdrawn. The service provider network module 114 and the lead pool 116 as well as other aspects of the service provider network are discussed in further detail below.

The architecture 100 shows three service providers: service provider Alpha 118, service provider Beta 120, and service provider Gamma 122. However, a service provider network may have a greater or lesser number of service providers. The agent 104 may be associated with any one of the service providers 118, 120, or 122. The agent 104 may be the owner of the service provider, an employee, a contractor, or be another one of the service providers 118, 120, or 122. Although the customer 102 may hire or pay one of the service providers 118, 120, or 122, the agent 104 is the person or persons physically on site at the customer location and able to interact face to face with the customer 102.

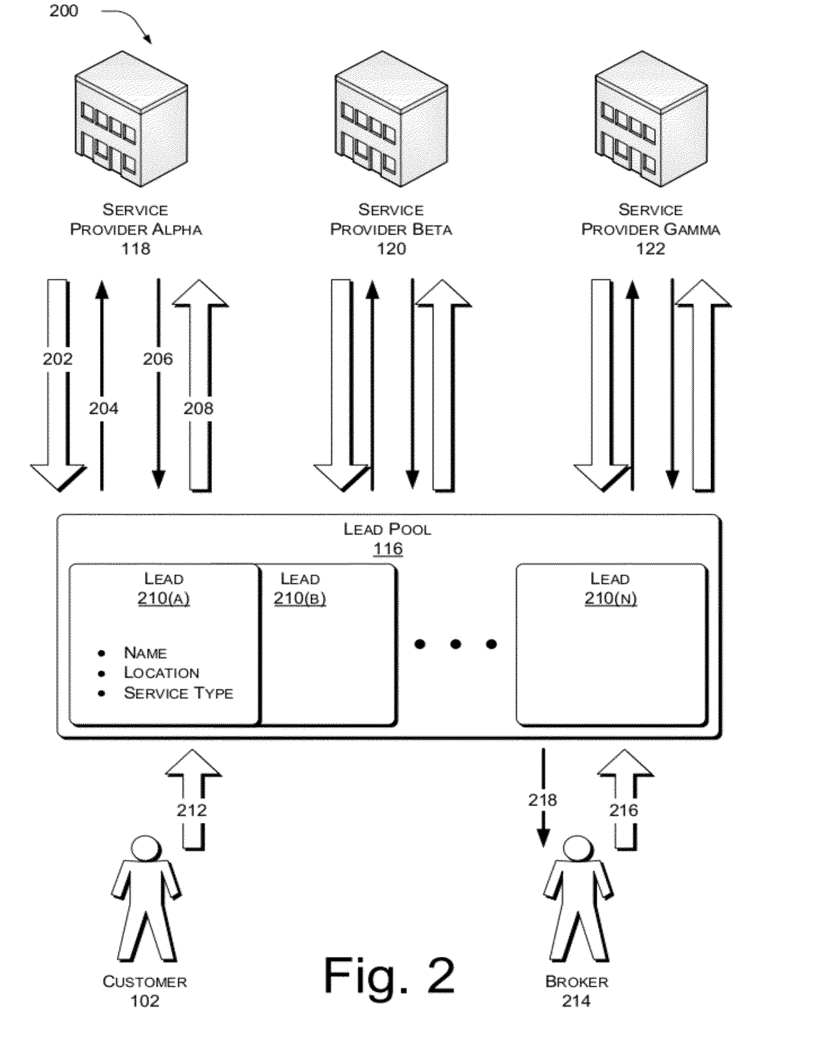

FIG. 2 shows an architecture 200 that includes the lead pool 116 of FIG. 1 in greater detail. As discussed above, the knowledge of an unfulfilled customer service need is identified as a “customer lead” or simply “lead.” Architecture 200 shows the service providers 118, 120, or 122 contributing and withdrawing leads from the lead pool 116. Here, the thick arrow 202 represents the contribution of a lead from service provider Alpha 118 to the lead pool 116. Service provider Alpha 118 may learn of the lead from an agent 104 who is at a customer location to provide a different type of service. Service provider Alpha 118 may also learn of the lead from the customer 102 contacting the service provider directly by phone, e-mail, or otherwise.

In exchange for contributing the lead to the lead pool 116 service provider Alpha 118 may receive a token or credit represented by the thin line 204. In some implementations, the number of token or credits received for contributing a lead may depend on the quality of the lead, the timeliness or “freshness” of the lead (i.e., a period of time between initial capture of the lead and withdrawal of the lead), the potential value of services represented by the lead, and/or other factors (i.e., a lead for a more expensive type of service may be worth more than a lead for a less expensive type of service).

The tokens or credits received from contributing a lead to the lead pool 116 may be paid in, as represented by thin line 206, to the lead pool 116 in order to withdraw a lead, as represented by thick line 208. Tokens or credits may be redeemable by a service provider for other things such as money, discounts for membership in the service provider network, etc. Each of the service providers 118, 120, and 122 may choose which leads to contribute. The service providers 118, 120, and 122 may also search for leads in the lead pool 116 to decide which leads to withdraw. This may optimize matching of a customer lead with the service provider that places the highest value on the lead and/or is best positioned to act on the lead.

The lead pool 116 may include N different leads 210(A), 210(B) . . . 210(N) where N is a number greater than 1. Each of the leads 210 may include a name of the customer, a location where the customer desires service, a general type of the service (e.g., furnace maintenance or accounting), more specific information about the type of service (e.g., type of furnace or size of business needing accounting), customer payment history, credit worthiness, timeframe during which the customer 102 desires service, and the like.

The service providers 118, 120, and 122 may be able to view only partial information about the leads prior to “purchasing” or withdrawing a lead 210 from the lead pool. For example, the customer name and contact information may be shown to the service provider 118, 120, or 122 only after the lead 210 is withdrawn from the lead pool 116.

Leads may be contributed to the lead pool 116 by entities other than the service providers 118, 120, and 122. For example, the customer 102 may contribute a lead directly to the lead pool 116 as shown by thick arrow 212. The server(s) 112 shown in FIG. 1 may support a customer portal (e.g., implemented as a website) that the customer 102 can access using his or her computing device 108. In one implementation, the customer may fill out a web form that describes the service need and other relevant information and this is then added to the lead pool 116 as a lead 210. Contribution of leads 210 from a customer 102 is not limited to web-based communication but may also be implemented through a telephone interface (e.g., touchtone and/or voice recognition), by filling out a postcard and mailing that to an address for entry into the lead pool 116, or by any other technique that can capture information about the customer's service need.

Leads may also be contributed to the lead pool 116 by a broker 214 who may be neither a customer 102 nor a service provider 118, 120, or 122. For example, the broker 214 may visit potential customers and collect information about service needs. The broker 214 may provide leads to the lead pool 116 with a mobile device such as the mobile device 106 or computing device 108 shown in FIG. 1. Leads provide by the broker 214 to the lead pool 116 are represented by the wide arrow 216. In exchange for providing the leads the broker 214 may receive some type of remuneration like credits or money represented by the thin line 218.

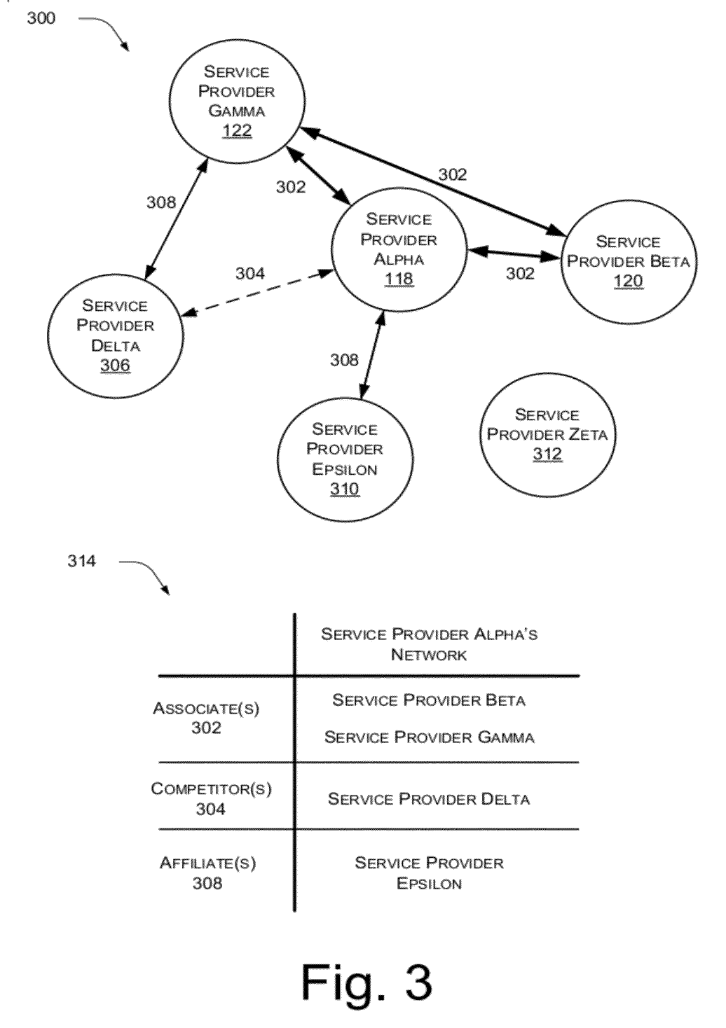

FIG. 3 shows an illustrative service provider network 300. Service provider Alpha 118 is at the center of the network 300. Service provider Alpha 118 and service provider Beta 120 are connected by a thick line representing an associate relationship 302. The associate relationship 302 may indicate that service provider Alpha 118 and service provider Beta 120 have chosen to have a close relationship in which both service providers may recommend one another to customers and provide cross referrals. An associate relationship may be established, for example, by service provider Alpha 118 sending an invitation or “association request” to service provider Beta 120 or service provider Beta 120 soliciting service provider Alpha 118 for permission to join an association established or managed by service provider Alpha 118. In some implementations, service provider Alpha 118 and service provider Beta 120 may provide complementary services such as carpentry and plumbing.

Service provider Alpha 118 and service provider Beta 120 may both have an associate relationship 302 with service provider Gamma 122. This may create an association of these three service providers. The association itself may have a separate identity within the service provider network. This may function to allow free sharing of customer leads within the association and/or allow any of the associates to commit services of the other association members. In some implementations, the creation of an associate relationship 302 may require that all other associates also form an associate relationship 302 with any new member (e.g., full cross association). In other words, if service provider Alpha 118 forms an associate relationship 302 with service provider Beta 120 and an associate relationship 302 with service provider Gamma 122, that may require that service provider Beta 120 also establish an affiliate relationship 302 with service provider Gamma 122.

Service providers that provide the same or similar types of services may have a competitive relationship 304 with one another. For example service provider Alpha 118 and service provider Delta 306 may both provide the same type of services and therefore have a competitive relationship 304 indicated by a dashed line. Each service provider when joining the service provider network may be required to select a one or more types of services that it provides. For example, plumbers may select plumbing services, masseuses may select massage services, etc. Service providers that select a same category of services may automatically be categorized as having a competitive relationship 304.

Service providers may also choose to have an “affiliate” relationship 308 with one another. An affiliate relationship 308 indicates the service providers are not competitors but are not as closely linked as associates. In the service provider network 300, service provider Alpha 118 has an associate relationship 308 with service provider Epsilon 310. Affiliate relationships 308 may provide for optional sharing of leads and secondary preferences for up-serving customers. For example, if service provider Beta 120 and service provider Epsilon 310 are both electricians then service provider Alpha 118 may preferentially recommend service provider Beta 120 (the associate) to customers with electrical service needs and only recommend service provider Epsilon 310 (the affiliate) when service provider Beta 118 is unable or unwilling to provide the needed electrical services.

In this example, service provider Delta 306 has an affiliate relationship 308 with service provider Gamma 122. Although service provider Alpha 118 has a competitive relationship 304 with service provider Delta 306 and service provider Gamma 122 is an associate of service provider Alpha 118 it may be possible for service provider Gamma 122 to form an affiliate relationship 308 with service provider Delta 306. The ability to form this affiliate relationship 308 may be modified by rules established by the association that includes service provider Alpha 118, service provider Beta 120, and service provider Gamma 122. In some implementations, it may not be possible for service provider Gamma 122 to form an affiliate relationship 308 with a service provider that is a competitor with one another member of the association (e.g., the association service provider Alpha 118 prevents an affiliation with service provider Delta 306).

Service providers in the network that do not have a relationship either formed automatically, such as a competitive relationship 304, or formed by mutual agreement between the service providers (e.g., associate or affiliate), may be uncategorized or unrelated service providers. For example, service provider Zeta 312 does not have a relationship with service provider Alpha 118. The lack of relationship may be the default situation in the absence of affirmative action by the service providers. Service provider Zeta 312 and service provider Alpha 316 may remain unassociated or unrelated unless and until those two service providers choose to establish an associate relationship 302 or an affiliate relationship 308.

Each service provider may also indicate multiple specialties or areas in which it provides service. For example, a masseuse may provide acupuncture services as well as massage services. A handyman may provide carpentry services as well as plumbing and electrical services. The ability of a service provider to designate that it offers multiple types of services may create various complex relationships. The masseuse may have a competitor relationship 304 with all other masseuses and with all other acupuncturists. It may be also possible for service providers to have relationships that are competitive 304 in part and affiliate 308 in part. For example, a handyman may have a competitive relationship with a specialized plumbing service provider for relatively simple plumbing service, but may have an affiliate 308 or even an associate 302 relationship with the specialized plumbing service provider for complex plumbing services. Thus, the level of difficulty or specificity of a service may determine the nature of the relationship between two service providers relative to that service.

The service provider network 300 shown here is but one representative network and actual networks may include a much larger number of service providers with relationships that form more complex networks and that may change over time. The service provider network 300 may further serve as a basis, at least in part, for capturing and sharing client leads and for up-serving clients by recommending and/or scheduling service with other service providers.

The network of service provider Alpha 118 is represented in tabular form in table 314. The table 314 shows that service providers Beta 120 and Gamma 122 have associate relationships 302 with service provider Alpha 118. Similarly, service provider Delta 306 is shown as having a competitor relationship 304. Service provider Epsilon 310 is shown as having an affiliate relationship 308. Thus, the table 314 presents another visualization of the service provider network 300.

### Illustrative Server

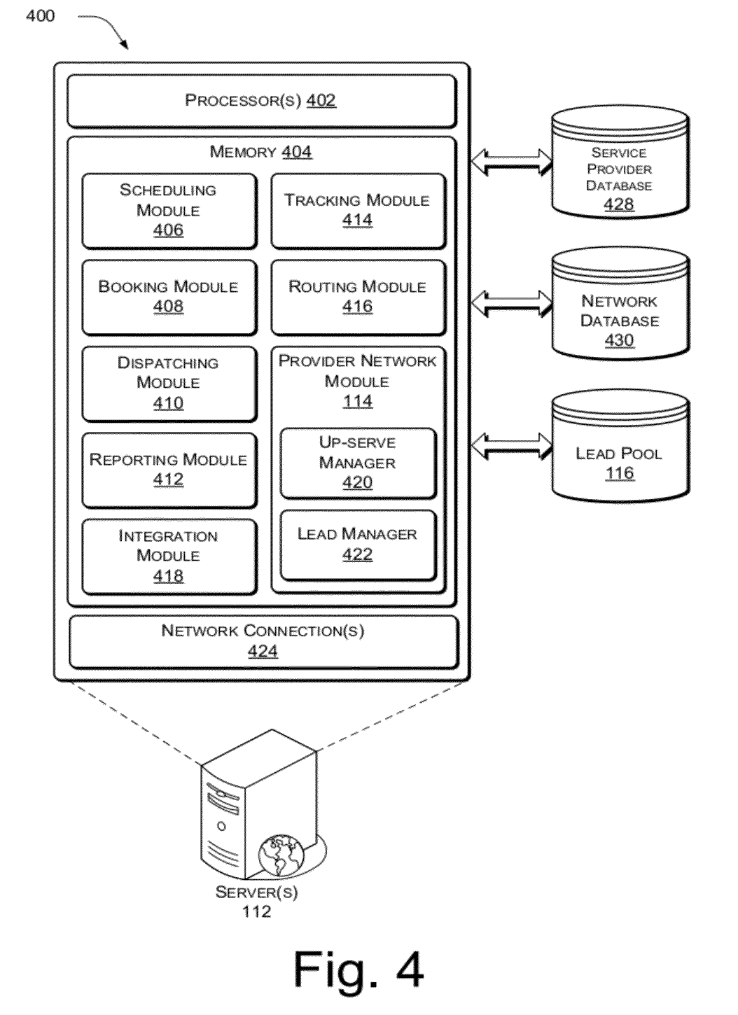

FIG. 4 is a block diagram 400 illustrating the server(s) 112 of FIG. 1 in greater detail. The server(s) 112 may maintain the service provider network and assist service providers in otherwise fulfilling customers' service needs. In some implementations, the server(s) 112 may provide backend support to the service providers and/or the agents of those service providers. This backend support may be provided in some implementations through the mobile device 106 as shown in FIG. 1.

The server(s) 112 may include one or more processors 402 and one or more instances of memory 404. The processors 402 and the memory 404 may be located on a single computing device (e.g., a network server) or may be distributed across multiple computing devices. The multiple computing devices may communicate though any type of interconnection that can convey information between the respective processors 402 and multiple instance of memory 404 (e.g., a bus system, a local area network, a wide area network, the Internet, a mesh network, an ad-hoc network, a peer-to-peer network or the like). The memory 404 may be implemented as computer-readable media that stores programs of instructions which are loadable and executable on the processor 402, as well as data generated during the execution of these programs. Depending on the configuration and type of computing device, memory 404 may be volatile (such as RAM) and/or non-volatile (such as ROM, flash memory, etc.). Computer-readable media implementations of the memory 404 can include, but are not limited to, magnetic storage, optical disks, tape storage, and/or any other tangible article of manufacture that is capable of storing program instructions and data.

The memory 404 may include a scheduling module 406, a booking module 408, a dispatching module 410, a reporting module 412, a tracking module 414, a routing module 416, a service provider network module 114, an integration module 418, and one or more additional modules. The modules may be representative of software, firmware, hardware, or mixtures thereof containing instructions that, when processed by a processor of a computing device, instruct a computing device to perform specific acts or algorithms.

The scheduling module 406 may optimize the assignment and allocation of resources for a service provider. The scheduling module 406 may maintain a calendar of resources available to service provider such as agents, crews of agents, available equipment, and other resources. Analysis provided by the scheduling module 406 may include ranking of the resources and/or agents in order to identify those that are best suited for filling a given customer service need. Analysis performed by the scheduling module 406 may recommend a best or optimal resource (e.g., an agent) based in part on customer information and information regarding the service need.

The booking module 408 may commit an appointment between a customer and a service provider. The booking module 408 may maintain a calendar of resources available to service provider such as agents, crews of agents, available equipment, and other resources. Analysis provided by the booking module 408 may include identifying available appointments in order to satisfy the availability of a given customer. Analysis performed by the booking module 408 may offer one or more appointments based in part on customer availability and service provider workload.

The dispatching module 410 may maintain a dispatch board that manages intraday movements and appointments for a service provider. The dispatching module 410 may assist the service provider in monitoring exceptional events and issues that arise in real time, and provide features to mitigate and manage these events.

The reporting module 412 may provide the ability to generate reports and produce other data and information output in order to tally, accumulate, summarize, or expose content persisted within the platform.

The tracking module 414 may track locations of the agents of a service provider. The agents may be tracked through the global positioning system (GPS) or other similar system. The tracking may be implemented by observing the positions of mobile devices carried by the agents, by tracking locations of vehicles used by the agents, or by another type of real-time observation of the agents' movements. Tracking may also be managed without a positioning system by the agent checking in with the tracking module 414 upon arrival at a customer location and possibly again when departing from the customer location. Thus, the tracking module 414 may track when the agent arrives and leaves customer locations and by knowing the customer locations (e.g., through accessing a database of customer information) the tracking module 414 can use that information to determine the location of the agent. Each agent may also have a defined start-of-day and end-of-day location which may be the location of the service provider's offices, the location of the agent's home, or another location.

The tracking module 414 may also contain map data and may determine the most efficient route for an agent to travel from customer to customer throughout the day. The tracking module 414 may also receive real-time traffic data and provide real-time analysis for routing an agent to a customer. This route may be updated dynamically if, for example, a service call extends longer than expected, there is an emergency need for services, traffic conditions change, or for another reason. The tracking module 414 may interface with the dispatching module 410 if it is determined to be more efficient to reassign a service call from one agent to another agent.

The routing module 416 may identify a most efficient route for the agent to move between customers and/or identify the next customer for the agent to visit. The routing module 416 may perform real-time analysis of traffic data received from the tracking module 414. The routing module 416 may also account for delays encountered by agents while in the field providing service. The routing module 416 may also suggest which agent, out of the agent's working for a service provider on a given day, can most efficiently reach a customer location and provide service. The suggestion may be based on locations of multiple agents, customer locations, travel time including traffic data, and/or other factors.

The service provider network module 114 may include the service provider network 300 shown in FIG. 3. When joining the service provider network each service provider may provide information to the service provider network module 114. This information may include an indication of types of services that are provided by the service provider. These services may be represented or indicated by service codes. The types of services provided by a service provider may be automatically analyzed by the service provider network module 114 to identify competitive relationships and suggest possible associate or affiliate relationships. For example, the service provider network module 114 may function similar to a matchmaker by suggesting that two or more service providers may wish to consider forming an associate or affiliate relationship. The matchmaking may be based at least in part upon types of services provided, geographic service areas, and the like.

The service provider network module 114 may also include an up-serve manager 420 and a lead manager 422. The up-serve manager 420 may receive and process requests from mobile devices to schedule service with a service provider in the service provider network. Up-serving is similar to a referral because one service provider recommends that a customer receive services from another service provider. However, up-serving may additionally allow an agent of the first service provider to commit the second service provider to provide those services.

As discussed above, an agent at a customer location may use a mobile device to communicate with the server(s) 112 in order to schedule future service for a customer. When this future service will be provided by another service provider, that scheduling is “up-serving” because the agent can offer the customer services beyond those provided by the service provider that is associated with the agent. The up-server manager 420 may identify other service providers based on information in the service provider network (e.g., specialties or qualifications). The up-serve manager 420 may also provide a list of possible service providers to the agent. The list may be a ranked list based on the type of relationship between service providers. For example, out of all the service providers capable of providing the needed service, associates may be listed first followed by affiliates and then by unrelated service providers.

Having this information conveniently available to the agent while at the customer location may allow the customer to identify quickly a service provider for another service need without searching through a telephone book or browsing the Internet. This server(s) 112 may allow the mobile device to access the scheduling module 406 and expose the schedule of another service provider to help the customer identify a date and time for scheduling service. The agent may use his or her mobile device not only to show the customer the scheduling calendar of the other service provider but also to modify the calendar and commit the other service provider to a service appointment with the customer. In some implementations, the up-serve manager 420 may limit access to the scheduling information for other service providers and may make that information available to the mobile device of the agent only when an up-serve opportunity has been indicated (e.g., calendars are kept private unless there is a possibility of a referral).

The up-serve manager 420 may also provide the mobile device with information about other service providers so that the customer may be able to view rates, reviews, expertise, and the like before selecting a service provider. In some implementations, the up-serve manager 420 may only provide the customer with information on a limited sub-set of service providers. For example, the choices presented to the customer on the mobile device may be limited to only associates of the service provider currently at the customer location. This opportunity to receive referrals through up-service from associated service providers may be a motivation for service providers to form associates in the service provider network.

Other entities, such as the broker 214 shown in FIG. 2, may also visit customer locations with a mobile device and work with the customer to schedule service calls with various service providers in the service provider network. The broker 214 may be a member of an association of service providers and only schedule service calls for members of that association (e.g., a sales representative for a group of service providers).

The lead manager 422 in the provider network module 114 may manage the addition and withdrawal of leads to and from the lead pool 116. Leads may be captured by any of the techniques discussed above such as by an agent at a customer location entering a lead into his or her mobile device. The agent may obtain a customer lead rather than up-serve the customer if, for example, the customer is not yet ready to commit to scheduling an appointment or if the customer is unsure of when he or she would like to receive the service.

The lead manager 422 may also include logic to analyze and recommend leads to a particular service provider. For example, the lead manager 422 may, in conjunction with the scheduling module 406, booking module 408, and/or the dispatching module 410, identify time periods of availability in a service provider's schedule and suggest a lead to the service provider based on the type of service desired, the time period during which the potential customer would like to schedule the service, and/or the customer location. In some implementations, the service provider may exchange tokens, credits, money, etc. in order to withdraw the lead as shown in FIG. 2.

The lead manager 422 may also receive leads from lead-generating entities other than service providers such as customers 102 and/or brokers 214 as shown in FIG. 2.

The integration module 418 may provide a mechanism for service providers to externally and programmatically access the data and information persisted within the platform. This may offer increased flexibility to service providers regarding the collection, analysis, and reporting of this data and information.

The server(s) 112 may additionally include one or more network connections 424 for communicating with the network 110 shown in FIG. 1.

The server(s) 112 may also include or be communicatively coupled to multiple data stores or databases such as a service database 428, a network database 430, and the lead pool 116.

The service database 428 deals with the service management functionalities available on the server(s) 112. The service management functionalities may include scheduling, booking, dispatching, reporting, tracking, routing, and/or integration, which may be handled at least in part by the respective modules on the server(s) 112. The service database 428 may include data about various service providers. The data for each service provider may be stored separately from the data of the other service providers in order to provide security and privacy. The data may include the types of services provided by a service provider, the names and qualifications of agents associated with that service provider, and inventory of equipment used for fulfilling customer service needs, hours of operation, prices, a geographic range where service is provided, and the like.

The network database 430 provides information utilized by the provider network module 114. This information may include information about customers and potential customers such as customer locations, past service received by a customer, unfulfilled service requests, and the like. The network database 430 may also serve as a repository for information collected from customers through a customer portal. The customer portal may be a website accessed by a customer from a computing device such as, for example, the computing device 108 shown in FIG. 1. In some implementations, the network database 430 may store the relationship information about various service providers. For example, the information that service provider Alpha and service provider Beta are affiliates may be stored in the network database 430 and analyzed by the provider network module 114.

The lead pool 116 may include customer leads as discussed previously. In some implementations, the lead pool 116 may be a component of the network database 430.

### Illustrative Mobile Device

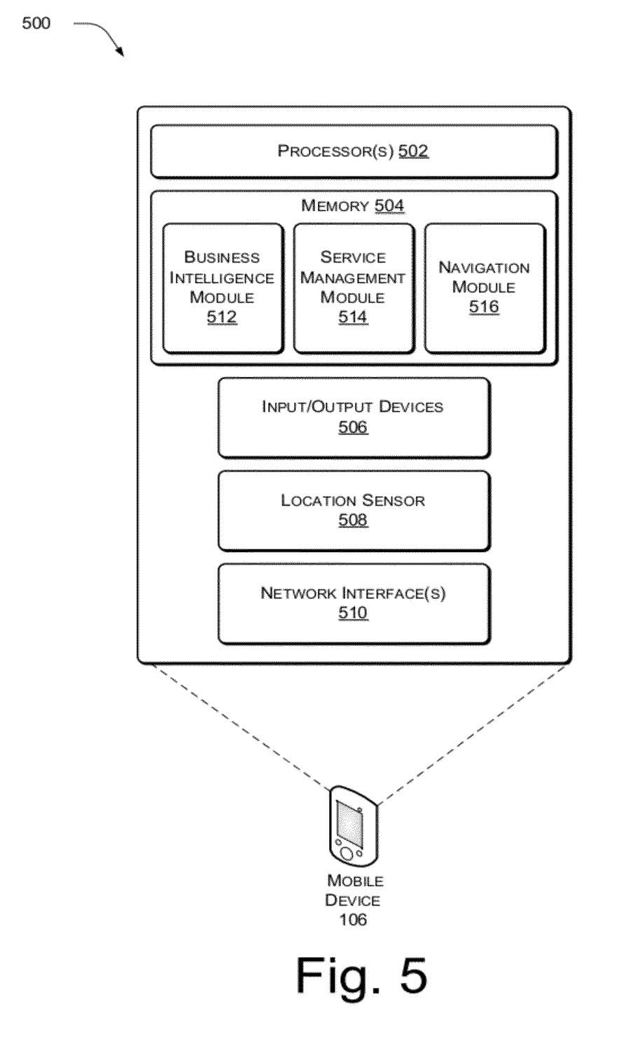

FIG. 5 is a block diagram 500 illustrating the mobile device 106 of FIG. 1 in greater detail. The mobile device 106 may be implemented as any type of mobile communications device such as a mobile phone, a smart phone, a mobile computer, a tablet computer, or the like. In a basic configuration, the mobile device 106 includes one or more processors 502 and a memory 504.

Mobile device 106 also includes one or more input and output devices 506. The output devices may comprise one or more display devices including touch-screen displays, speakers, a vibrator or other haptic signal generator, a printer, etc. The input devices may include touch pads, touch-screen displays, keypads, keyboards, an accelerometer that detects rotation or vibration, a microphone, a camera, etc.

In some implementations, the mobile device 106 may also include a location sensor 508. The location sensor 508 includes any sort of system that informs the mobile device 106 of its location including, but not limited to, the Global Positioning System (GPS) of satellites circling the Earth. Alternatively, the location sensor may determine location by radio signal triangulation (e.g., triangulation based on radio antenna signal strength), signal strength (e.g., of a cell phone tower or a wireless hotspot), and the like.

One or more network interfaces 510 in the mobile device 106 may be configured for wirelessly communicating with the network 110. The network interface(s) 510 may use any standard protocols for network communication such as wireless telephone or wireless Internet protocols.

The memory 504 may include a business intelligence module 512, a service management module 514, and a navigation module 516. The business intelligence module 512 may analyze data about a customer to provide an agent on site at the customer location with recommendations of additional business opportunities. For example, the business intelligence module 512 may analyze past frequency, cost, and nature of service calls made to the customer location. This information may be used to determine if an alternate billing plan or service contract would be beneficial to the customer. For example, if the customer has had three service visits for furnace repair within the last 12 months, the business intelligence module 512 may determine that a service contract would save the customer money over the next year and suggest this to the agent using the mobile device. The agent will then be able to present this option to the customer.

Connection to the network and also to the service provider network may allow the business intelligence module 512 to analyze customer service needs, behaviors, and patterns across multiple service providers. For example, if this customer had recently received services for plumbing, electrical, and furnace service (e.g., the customer lives in an older house) the business intelligence module 512 may compare pricing and service options across different service providers and generate a service contract for multiple types of services provided by more than one service provider.

The service management module 514 may manage the service history of the customer. For example, the service management module 514 may determine if the customer is eligible for a discount or coupon and provide the agent with an opportunity to share that discount or coupon with the customer during a service visit.

The navigation module 516 may function to assist in guiding the agent to a customer location. In some implementations, the navigation module 516 may provide detailed turn-by-turn directions. In other implementations, the navigation module 516 may inform the agent of the identity and address of the next customer requiring service. The navigation module 516 may communicate with modules on the server(s) 112 such as the dispatching module 410, the tracking module 414, and the routing module 416. The navigation module 516 may also provide navigation in part based on information received from the location sensor 508.

### Illustrative Processes

For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and any number of the described process blocks may be combined in any order to implement the process, or an alternate process. Moreover, it is also possible that one or more of the provided operations may be modified or omitted.

The processes are illustrated as a collection of blocks in logical flowcharts, which represent a sequence of operations that can be implemented in hardware, software, or a combination of hardware and software. For discussion purposes, the processes are described with reference to the systems, devices, and architectures shown in FIGS. 1-5. However, the processes may be performed using different systems, devices, and/or architectures.

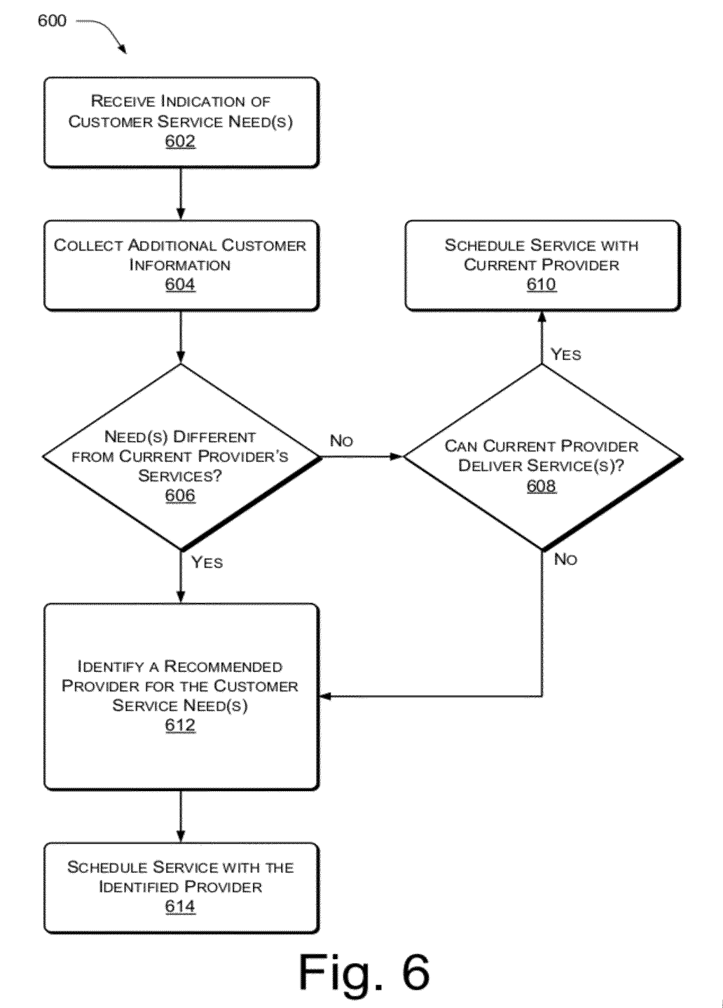

FIG. 6 is a flow diagram of an illustrative process 600 for identifying a service provider to meet a customer need. At 602, indication of a customer service need or needs is received. The indication may be received directly from the customer through a web portal, an e-mail message, a phone call, or otherwise. The indication may also be received from an agent of a service provider who is at the customer location. In some implementations, the agent may enter this indication of customer need(s) into a mobile device. For example, if the mobile device is a mobile phone, the agent may send a text or short message service (SMS) message to a designated phone number. Text messages received at the phone number may be provided to a server such as the server(s) 112 shown in FIGS. 1 and 4. In other implementations, a broker may learn of the customer service need through communications or interactions with the customer and communicate the customer service need to the server(s) 112 via a mobile device, telephone, or other computing device.

At 604, additional customer information is collected. The additional customer information may include specifics about the customer service need and/or information about the customer generally. For example, the information collected at 604 may include location (e.g., address), category and subcategory of service need, preferred date and/or time to receive the service, past payment history, credit worthiness, and the like. The additional customer information may be collected directly by a service provider, an agent, a broker, or another entity.

At 606, it is determined if the customer service need(s) are different from services provided by a service provider receiving the indication of service need at 602. The provider that received the initial indication of a service need is referred to herein as a “current service provider.” For example, an agent of a plumber (i.e., current service provider) while at the customer location to fix a broken pipe may learn that the customer also has a need for service to a water heater. If both of these services are the type of services performed by the plumber then the customer's service need is not different from range of services provided by the current service provider. Therefore, process 600 proceeds along the “no” path to 608.

At 608, the current service provider (e.g., the plumber) determines if it can deliver the needed services. For example, due to scheduling conflicts, employee vacations, geographic location of the customer, necessary parts or equipment, or other reasons the service need may be of a type provided by the current service provider, but for other reasons the current service provider may be unable to service that need. If the current service provider is able to deliver the needed services, then process 600 proceeds along the “yes” path to 610.

At 610, service is scheduled with the current service provider. This may be thought of as the most straightforward path for scheduling a service appointment. In short, a service provider receives an indication of customer service need that is of the type provided by the service provider and nothing else (e.g., scheduling conflicts) prevents the service provider from delivering the needed service.

However, if there are reasons why the current service provider cannot deliver the needed services then process 600 proceeds along the “no” path from 608 to 612

Also, if at 606 it is determined that the customer needs different services than those provided by the current service provider, process 600 proceeds along the “yes” path from 606 two 612. For example, if a plumber receives a phone call from a customer looking for service to a sprinkler system, this may be a type of service that is not provided by the plumber but may be provided by a service provider that performs landscaping and irrigation services.

At 612, a recommended service provider for the customer service need(s) is identified. Determination of a recommended service provider may involve consideration of numerous factors related to the customer's service need and multiple service providers. Artificial intelligence, probabilistic analysis, fuzzy logic, inference based determination or any other type of computer-based decision making techniques may be applied to determine which service provider is “best” for a given set of circumstances.

In one implementation, the indication of the service need(s) received at 602 and/or the additional customer information received at 604 may be applied as filters to remove service providers that do not match the customer needs. If the filtering results in identification of only one service provider, then the single identified service provider may be the “recommended” service provider for the customer service need. However, if no service providers remain after filtering, or if more than one service provider meets all of the requirements specified by the filtering, further analysis may be necessary to identify which of those is recommended for meeting the customer service need(s). In some implementations, each of the factors that are considered when identifying a recommended service provider may be weighted and each possible service provider may be scored based on a value derived from the weighted factors. A highest scoring service provider could be identified as the recommended service provider, the next highest scoring service provider may be identified as the next recommended service provider, and so on. A relationship between the current service provider who is unable to fill the customer service need(s) and other service providers may be one of the factors considered in selecting a recommended service provider.

At 614, service is scheduled with the identified service provider. The service may be scheduled directly by the customer contacting the identified service provider. Alternatively, an agent of the current service provider interacting with the mobile device or a broker interacting with a mobile device or other computing device may schedule the appointment for the customer. When an agent of a service provider that is itself unable to provide the user customer service provides scheduling of the needed customer service with a different service provider this is “up-serving” the customer as discussed above.

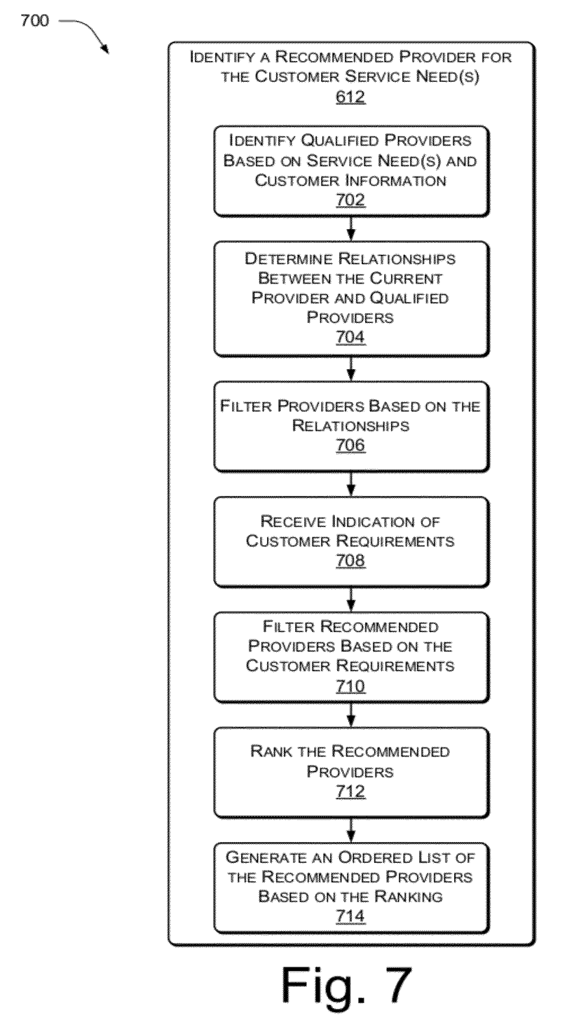

FIG. 7 is a flow diagram on an illustrative process 700 showing additional aspects of identifying a service provider to meet a customer need shown at 612 in process 600.

At 702, qualified service providers are identified based on the service need(s) of the customer received at 602 and the customer information received at 604. In one implementation, the qualified service providers may be all service providers that offer services of the type needed by the customer. For example, if the customer needs a virus removed from a computer then the qualified providers may include all service providers in the service provider network that provide computer or information technology (IT) support. The customer information may be used to further identify a qualified service provider for example the identifying service providers that are within a specific geographical range of the customer location (e.g., within 15 miles). The customer may also have specific service providers that he or she likes or dislikes and this information may be part of the customer information which is used to identify qualified service providers. In some implementations the identifying may include one or more filtering steps applied to the service providers that are included in the service provider network.

At 704, relationships between the current service provider and the qualified service providers identified at 702 are determined. As discussed earlier, the current service provider may be the service provider that initially receives an indication of customer service need(s) at 602. When this service provider cannot fulfill the identified service need, the current service provider may prefer that another service provider with which it is associated receive an opportunity to provide the needed service(s).

The types of relationships between service providers and service provider network may be competitive, affiliate, associate, no relationship, or other types of positive and/or negative relationships. The qualified service providers identified at 702 may have one of the above types of relationships with the current service provider or the service provider network may not show any type of relationship. The determination at 704 may create a list of service providers that includes those service providers that are qualified to perform the services and includes the relationships between those service providers and the current service provider (i.e., the service provider making the referral).

At 706, recommended providers are filtered based on the relationships determined in 704. The type of relationship between the current service provider and the qualified service providers may determine which of the qualified service providers are recommended to the customer. For example, qualified service providers that have an associate relationship with the current service provider may be recommended exclusively.

At 708, indications of customer requirements are received. In one implementation, the indications may be received by the server(s) 112 via the mobile device 106 as shown in FIG. 1. The customer requirements may include more detailed information about the specific service(s) required, preferred temporal aspects of scheduling such as day of the week, time of date, specific dates, and the like. The customer requirements may also include information that was not captured earlier, but is obtained by an agent or broker through interaction and discussion with the customer. For example, the customer's location may be a type of additional customer information obtained at 604 from a customer database but the customer's preference for receiving service in the late afternoon may be a customer requirement received at 708. The customer requirements may also vary with each service request (e.g., the preferred time of receiving service may be different for each service request).

At 710, the recommended providers may be filtered based on the customer requirements. Out of all the service providers that the current service provider can recommend, there may be a subset of those that do not meet the customer requirements received at 708. For example, the customer may request service on Saturday and there may be recommended service providers that do not work on weekends. Similarly the customer may further specify that he or she needs a virus removed from an Apple® computer and some of the recommended service providers may only provide support for Microsoft Windows® based computers. Filtering at 710 may remove these recommended service providers that do not meet the customer requirements received at 708.

At 712, the recommended service providers which are not removed by filtering at 710 are ranked. The ranking may be based on consideration of numerous weighted or unweighted factors. These factors may include the type of customer service need, the additional customer information, the customer requirements, the relationship between the recommended service provider and the current service provider, and the like. Each of the factors may receive a weighting based on importance to the customer and/or importance to the current service provider. In some implementations, this weighting may be provided by the server(s) 112 for example by the up-serve manager 420.

At 714, an ordered list of the recommended service providers based on the ranking at 712 is generated. Service providers that receive a higher recommendation may appear sooner or more prominently in the list. The ranked list of service providers may be displayed on the mobile device. The mobile device may be viewed by the agent, broker, and/or customer in order to consider which of the service providers to select. Once a one of the recommended service providers may be selected by the customer, service with the provider may be scheduled at 614 as discussed above.

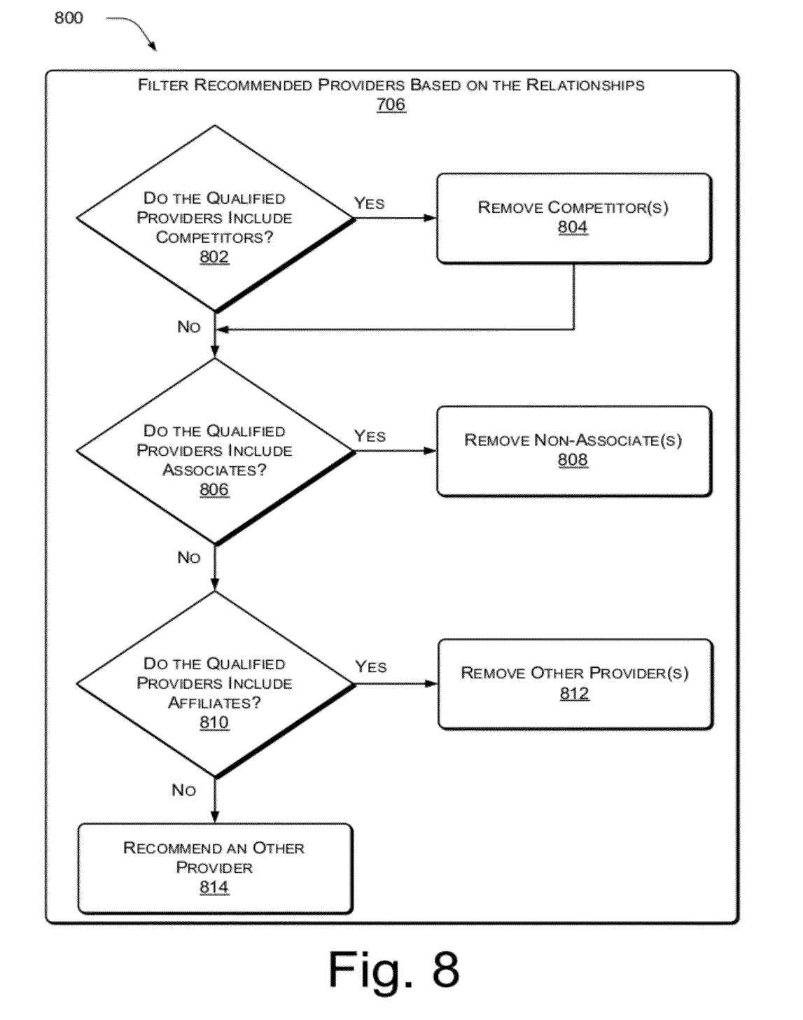

FIG. 8 is a flow diagram of an illustrative process 800 showing additional aspects of identifying a recommended service provider based on a relationship as shown above at 706 in process 700. The relationships between service providers represented in the service provider network, such as the illustrative network shown in FIG. 3, may be used as one of factor for up-serving customers, providing referrals to customers, and the like.

At 802, it is determined if the qualified providers identified at 702 include competitors of the current service provider. This could occur if, for example, the current service provider provides only carpentry services and the customer needs electrical services and a competitor provides carpentry as well as electrical services. Therefore the competitor may be classified as a competitor because the competitor provides carpentry services and may be identified as a qualified service provider because it provides electrical services.

When the qualified service providers include competitors, process 800 proceeds along the “yes” path to 804. At 804, a decision may be made to not recommend the competitor. Returning to process 700, the decision made at 804 will exclude competitors from the recommended service providers identified at 706.

When the qualified service providers do not include competitors, process 800 proceeds along the “no” path from 802 to 806. Similarly, when qualified service providers that are competitors have been removed for the set of recommended service providers, process 800 proceeds from 804 to 806.

At 806, it is determined if the qualified service providers include an associate. This determination may be performed in whole or part by the server(s) 112 utilizing the provider network module 114 and/or the network database 430. In some implementations, an associate relationship may be the strongest type of relationship between two service providers in the service provider network and may also imply a requirement for exclusive cross referrals and up-serving. Each association may include only one associate for each type of service (e.g., service provider code). Therefore, if there is a qualified service provider for the needed service in the association, there may be at most one qualified associate. Accordingly, if the qualified service providers include an associate, process 800 may proceed along the “yes” path to 808.

At 808, non-associates (e.g., affiliates and/or un-associated service providers) are removed and the associate is identified as a recommended service provider. If however, the qualified service providers do not include an associate of the current service provider (e.g., perhaps a plumber was asked for a referral to a masseuse and the plumber has not formed an associate relationships any masseuses) process 800 proceeds along the “no” path from 806 to 810.

At 810, is determined if the qualified service providers include any affiliates of the current service provider. Recall from the discussion accompanying FIG. 3 that an affiliate relationship is a positive relationship between two service providers but not as strong as an associate relationship. Affiliates may actively promote each other's businesses but are not necessarily required to have any exclusivity in the relationship.

If the qualified service providers do include affiliates, process 800 proceeds along the “yes” path to 812. At 812, the one or more affiliates are identified as recommended service providers through filtering out of other qualified service providers that do not have a relationship with the current service provider. When more than one affiliate has been identified, thus giving the customer multiple choices, all of the qualified affiliate service providers may be ranked and placed in an ordered list as shown above in 712 and 714 of process 700. In this implementation, by preferentially recommending associate service providers before affiliate service providers, an incentive may be created for a service provider to associate with other service providers that are likely to provide referrals.

If, however, the qualified service providers do not include any affiliates, as well as not including any associates as determined at 806, process 800 proceeds along the “no” path from 810 to 814. At 814, one or more other service providers without a defined relationship with the current service provider may be identified as service providers to recommend to the customer. The recommendation may involve ranking and placing all of the qualified service providers in an ordered list as shown above in 712 and 714 of process 700.

In some implementations, the recommendation and/or eventual appointment scheduling through up-serving may lead to the current service provider and the other service provider to create an associate or an affiliate relationship. For example, along with receiving the booking or scheduling of the customer, the other service provider may also receive a communication, in some implementations generated by the up-serve manager 420 of the provider network module 114, suggesting or inviting the service providers to designate a type of relationship (e.g., affiliate or associate).

Although the process for identifying recommended service providers shown in FIG. 8 imposes a hierarchy based on type of relationship (i.e., recommend affiliates if and only if no associates are available), the customer may be provided with options to select from service providers that are competitors, associates, affiliates, and/or those without an established relationship to the current service provider. In some implementations, the ranking performed at 712 in process 700 may rank associates higher than affiliates and affiliates higher than unrelated service providers.

Depending on the relative weighting of this factor, all associates may appear first in the list. For example, the mobile device may display the list of qualified service providers with the associates shown at the top of the list. Similarly, all the affiliates may appear next on the list and all of the service providers without a defined relationship to the current service provider may appear last. In other implementations, the list of qualified service providers may include an unrelated service provider as higher ranked than an affiliate service provider based on customer requirements and/or additional customer information such as the customer service location or particular model of equipment that requires servicing.

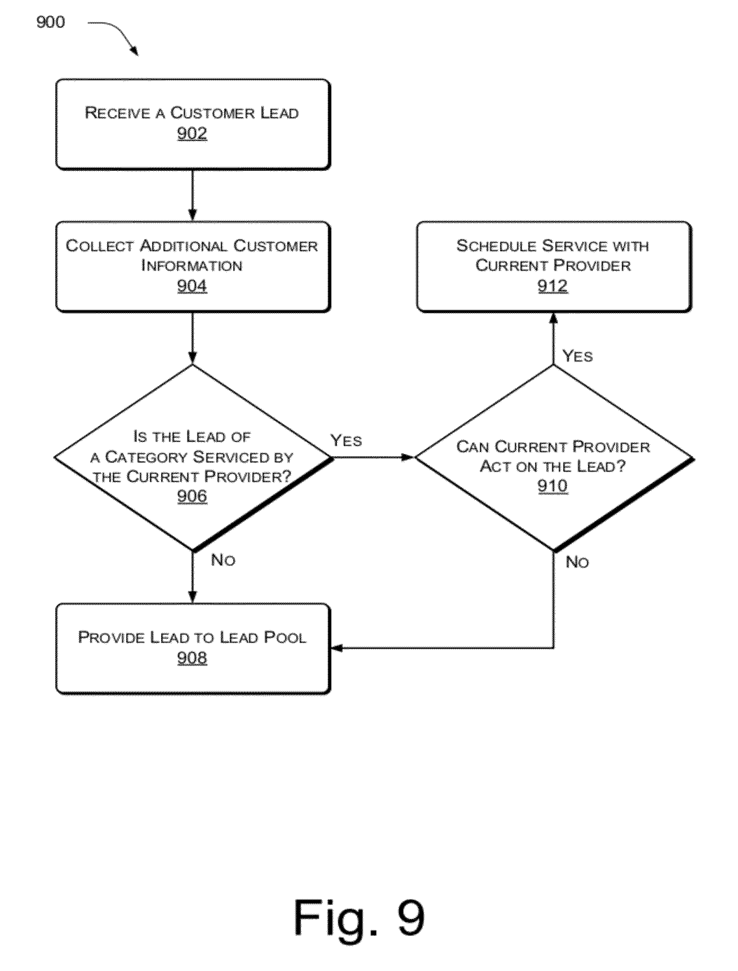

FIG. 9 is a flow diagram of an illustrative process 900 for providing a customer lead to a lead pool. As discussed above, an indication of a customer need for service that is not filled by receiving the service or by having an appointment scheduled with a service provider to receive the service in the future may be identified as a lead. The service provider network may additionally facilitate sharing and distribution of leads as well as providing up-service as described above in connection with FIGS. 6-8.

At 902, a customer lead is received. In one implementation, a customer lead is received by the server(s) 112 via the mobile device 106 as shown in FIG. 1 when an agent or a broker is present at a customer location. In a basic configuration, the customer lead may simply indicate a customer by name and possibly customer location as well as the general class of service needed by the customer. For example, the customer lead may include information that Peter Piper at a particular latitude and longitude (e.g., as determined by the location sensor 514 of the mobile device 106) desires the services of a plumber.

At 904, additional customer information is collected. In some implementations, the customer information may be entered into the mobile device 106. In other implementations, the customer information may be received over the phone, via e-mail, via a website, or any other communication medium. The additional customer information may include further specifics about the desired service, desired scheduling times and dates, a budget of the customer (i.e., an amount of money the customer is willing to pay for the service), and the like.

At 906, it is determined if the lead is of a category of service that is provided by the current service provider. The service category may be classified by a general service category (e.g., plumbing) and additional, more specific, service categories (e.g., water heating systems). For example, if the current service provider is an electrician and the lead indicates that Peter requires plumbing services then that lead is not of a category of service that an electrician provides. When the lead is not of a category that can be serviced by the current service provider (e.g., outside of that service provider's specialty) then process 900 proceeds along the “no” path to 908. However, if the lead is of a category is serviced by the current service provider then process 900 proceeds along the “yes” path to 910.

At 910, it is determined if the current provider can act on the lead. The current provider can act on the lead if it has the resources and if there are no conflicts preventing it from providing the service(s) desired by the customer. If the current service provider is able to act on the lead then process 900 proceeds along the “yes” path to 912 and the current service provider schedules a service appointment with the customer. The scheduling may be done by an agent of the service provider at the customer's location using a mobile device.

However, in some circumstances the lead is in a category that matches the current service provider (e.g., a plumber receives a lead to provide plumbing services) but it may not be possible for the current service provider to act on this lead. For example, the additional customer information collected at 904 may indicate that the customer needs emergency service and requires a same-day appointment. If the current service provider has a fully booked schedule for the day then it is not able to act on the lead. When the current service provider cannot act on the lead, process 900 proceeds along the “no” path to 908.

At 908, the lead may be provided to the lead pool. The lead pool may be the same as the lead pool 116 shown in FIG. 1. Once in the lead pool, the lead may be withdrawn by any of the techniques discussed above in conjunction with FIG. 2.

### CONCLUSION

The subject matter described above can be implemented in hardware, software, or in both hardware and software. Although implementations have been described in language specific to structural features and/or methodological acts, it is to be understood that the subject matter defined in the appended claims is not necessarily limited to the specific features or acts described above. Rather, the specific features and acts are disclosed as illustrative forms of illustrative implementations of scheduling service for customers and tracking customer leads. For example, the methodological acts need not be performed in the order or combinations described herein, and may be performed in any combination of one or more acts.

What is claimed is:

1. Computer-readable media comprising instructions, that when executed by one or more processors, cause a mobile device of a first service provider to:
receive an indication of a customer service need for a customer;
collect additional customer information regarding at least one of the customer or the customer service need;
determine that the first service provider is unable to fulfill the customer service need based at least in part on the additional customer information;
identify a second service provider to meet the customer service need; and
schedule a service appointment with the second service provider.

2. The computer-readable media of claim 1, wherein the additional customer information comprises at least one of a location of the customer, a time for the customer to receive the service, or a payment history of the customer.

3. The computer-readable media of claim 1, wherein the additional customer information comprises a time for the customer to receive the service and the first service provider is unable to fulfill the customer service need due to another scheduled activity during the time for the customer to receive the service.

4. The computer-readable media of claim 1 further comprising, instructions executed by the one or more processors that cause the mobile device of the first service provider to:
identify a plurality of other service providers based at least in part on a correlation between the indication of the customer service need and services provided by the other service providers;
receive an indication of customer requirements for fulfilling the customer service need;
filter the plurality of other service providers based at least in part on the customer requirements to identify a subset of the plurality of other service providers that fulfill the customer requirements;
rank the subset of service providers to generate an ordered list;
receive a selection of one of the subset of service providers from the ordered list; and
identify the selected one of the subset of service providers as the second service provider.

5. The computer-readable media of claim 4, wherein the instructions to rank the subset of service providers comprises instructions to rank based at least in part on a type of customer service need, the additional customer information, the customer requirements, or a relationship between the first service provider and individual ones of the subset of service providers.

6. The computer-readable media of claim 4 further comprising, instructions executed by the one or more processors that cause the mobile device of the first service provider to:
filter the plurality of other service providers based at least in part on a type of relationship between the first service provider and individual ones of the other service providers, wherein the types of relationships comprise a competitor relationship, an associate relationship, or an affiliate relationship.

7. The computer-readable media of claim 6 further comprising, instructions executed by the one or more processors that cause the mobile device of the first service provider to:
determine if the subset of service providers includes one or more service providers having an associate relationship with the first service provider;
when one or more of the service providers has an associate relationship, remove other service providers with a relationship other than an associate relationship from the subset of service providers;
when one of the service providers does not have an associate relationship, determine if the subset of service providers includes one or more service providers having an affiliate relationship with the first service provider;
when one or more of the service providers has an affiliate relationship, remove service providers without an established relationship with the first service provider from the subset of service providers.

8. The computer-readable media of claim 7 further comprising, instructions executed by the one or more processors that cause the mobile device of the first service provider to, when the type of relationship is the competitor relationship, remove the service provider from the subset of service providers.

9. The computer-readable media of claim 1, wherein the instructions to schedule the service appointment comprise instructions to modify a calendar of the second service provider and commit the second service provider to the service appointment.

10. A method comprising:
receiving, at a mobile device of a service provider, a customer lead comprising an unfilled need by a customer for a service;
collecting, at the mobile device, additional customer information;
receiving an indication that the customer lead is not in a same service category as a service category served by the service provider; and
providing the customer lead from the mobile device to a lead pool.

11. The method of claim 10, wherein the customer lead comprises a customer identifier and a general service category of the service need.

12. The method of claim 10, wherein the additional customer information comprises at least one of a specific service category of the service need, a scheduling preference of the customer, or a budget of the customer.

13. The method of claim 10, wherein the indication is received from a user of the mobile device.

14. The method of claim 10, wherein the indication is received from a computing device based at least in part on a determination by the computing device that the customer lead is not in the same service category as the service category served by the service provider.

15. The method of claim 10, wherein the service category served by the service provider is classified at least in part according to a general service category and at least in part according to a specific service category and wherein the indication is based at least in part on a determination that considers both the general service category and the specific service category.

16. The method of claim 10 further comprising, wherein the service provider receives a credit when the customer lead is provided to the lead pool, the credit redeemable by the service provider to withdraw a different customer lead from the lead pool.

17. The method of claim 16, wherein a value of the credit is based at least in part on an amount of time between receipt of the customer lead and a present time or on a potential value of the unfulfilled need, and wherein a quantity or type of leads for which the credit may be redeemed is based at least in part on the value of the credit.

18. A system comprising:
one or more processors;
a service provider database accessible by the one or more processors and comprising identities of a plurality of service providers and types of services provided by respective ones of the plurality of service providers; and
a memory coupled to the one or more processors, the memory comprising:
a service provider network module configured to analyze the types of services provided by the plurality of service providers and, based at least in part on the types of services provided by the plurality of service providers to identify competitive relationships and to suggest, to at least two of the plurality of service providers, forming a competitor relationship, an associate relationship or an affiliate relationship; and
an up-serve manager configured to receive an indication of a service need from a mobile device of one of the plurality of service providers, identify, from the service provider database, one or more other service providers that are capable of meeting the service need, and commit one of the identified service providers to provide the service.

19. The system of claim 18, wherein the service database comprises at least one of identities and qualifications of agents, inventory of equipment, hours of operation, prices, or a geographical range where service is provided.

20. The system of claim 18, wherein the one or more other service providers identified by the up-serve manager comprise service providers having an associate relationship with the one of the plurality of service providers.

21. The system of claim 18, further comprising:
a lead pool accessible by the one or more processors and comprising a plurality of customer leads, each lead including an identity of a customer and type of service needed by the customer; and
wherein the memory further comprises a lead manager configured to add a lead to the lead pool at least partially responsive to a lead-generating entity providing, from a mobile device, the lead and configured to remove the lead from the lead pool at least partially responsive to one of the plurality of service providers withdrawing the lead from the lead pool.

22. The system of claim 21, wherein the lead-generating entity comprises one of the plurality of service providers, the customer, or a lead broker.
